(19) United States
(12) Patent Application Publication
(10) Pub. No.: US 2003/0198036 A1
(43) Pub. Date: Oct. 23, 2003

(54) Key backlight control method and circuit

(76) Inventor: Masafumi Nakamura, Saitama (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/419,743

(22) Filed: Apr. 22, 2003

(30) Foreign Application Priority Data
Apr. 23, 2002 (JP) 120626/2002

(51) Int. Cl. H04M 1/22

(52) U.S. Cl. 362/24; 362/85; 362/88

(57) ABSTRACT

A key backlight control method and circuit can be provided by illuminating only the keys to be operated with the power consumption for a key arrangement unit reduced. The key arrangement unit is configured by a plurality of keys and LEDs for respectively illuminating the keys. The LEDs are controlled by a LED control unit, FETs, a scan register unit, and a CPU unit such that only the LEDs corresponding to the keys required (or requested) in the processing mode (browsing mail, etc.) can be turned on in the mobile terminal equipment such as a mobile phone unit.

### BACKGROUND OF THE INVENTION

1. Field of the Invention

The present invention relates to a key backlight control method and circuit, and more specifically to a key backlight control method and circuit capable of illuminating only the keys to be depressed in a mobile terminal device or the like.

2. Description of the Prior Art

FIG. 4 shows the appearance of mobile terminal equipment. Mobile terminal equipment 100 is a mobile phone unit, and includes an upper housing 101 is coupled to a lower housing 102 with a hinge unit 103 in a bifold structure. The upper housing 101 includes a display device (LCD) 104, a speaker 105, an antenna 106, etc., and the lower housing 102 includes keys 107 (ten-keys, a power on/off key (connection/disconnection key), a determination key, an up-down key, a left-right key, various function keys, a menu key, etc.), a microphone 108, etc.

When the keys 107 are operated in the mobile terminal equipment 100 as shown in FIG. 4, the keys whose operation surfaces are made of a semitransparent material are illuminated from inside using a backlight for easy operation in the dark, thereby improving the operability. The light sources of the backlight of a mobile phone unit or the like can be light-emitting diodes (LED) which are free of a broken wire and require low power consumption.

FIG. 5 shows the configuration of the conventional key control system and key backlight control circuit in the mobile terminal equipment.

The key control system includes a key arrangement unit 201 on which a plurality of push keys (24 keys in this example) whose operation surfaces are made of a light transmission material are arranged in the form of a matrix, a scan register unit 202 for sequentially controlling and scanning FETs 207a to 207c, a power supply unit 203 for pulling up a signal line to a NAND gate 204 into a high state, eight-input NAND gate 204, a key information register unit 205 for holding key depressing information when an interruption occurs, a CPU unit 206 for receiving a key input interruption from the NAND gate 204, the FETs (field effect transistors) 207a to 207c connected to the output terminal of the scan register unit 202, and resistances 208a to 208h whose one terminal is connected to the power supply unit 203, and whose other terminal is connected to each input signal line of the NAND gate 204.

The key LED control system includes an LED control unit 209, resistances 210a to 210j commonly connected to the LED control unit 209, LEDs 211a to 211j respectively connected to the resistances 210a to 210j. The LEDs 211a to 211j can come in luminous colors such as white, green, etc., and distributed onto the back of the key arrangement unit 201 such that each key can be illuminated from the back at equal intensity.

The key arrangement unit 201 includes keys 201a to 201x and eight row lines 212a to 212h and three column lines 213a to 213c connected to them. The other ends of the resistances 208a to 208h, each input of the NAND gate 204, and the key information register unit 205 are connected to the row lines 212a to 212h. Furthermore, the drains of the FETs 207a to 207c are connected to the column lines 213a to 213c.

The CPU unit 206 controls the scan register unit 202 according to an output signal of the NAND gate 204. The scan register unit 202 sequentially turns on the FETs 207a to 207c, that is, the column lines 213a to 213c, according to the signal from the CPU unit 206, and performs a scanning operation. Since the switching of the FETs by the scan register unit 202 is sufficiently quick, all keys can be scanned when a key is once depressed. At this time, since power is supplied from the power supply unit 203 to the row lines 212a to 212h through the resistances 208a to 208h, the voltage change of a depressed key is detected by the NAND gate 204 when any of the keys 201a to 201x is depressed, and therefore the CPU unit 206 can detect which key has been depressed. The key information register unit 205 holds the state of the signal line (row lines 212a to 212h) connected to the input side of the NAND gate 204, sets all signal lines in a high state before a key is depressed. When a key is depressed, it sets the signal line in a low state when the FET connected to the key is turned on. When a signal is transmitted from the NAND gate 204, the CPU unit 206 recognizes which key has been depressed by obtaining the information which FET is turned on and the information from the key information register unit 205 (which bit is set in the low state).

On the other hand, the LED control unit 209 is driven as necessary, the LEDs 211a to 211j are electrified in a predetermined procedure through the resistances 210a to 210j, and the LEDs 211a to 211j are turned on.

However, since the conventional key backlight control circuit is provided with a plurality of LEDs as light sources, the entire operation surfaces of the keys require the current of tens of mA although the current consumption of one LED is several mA. With mobile terminal equipment, especially a mobile phone unit, it is necessary to save power consumption, but the power consumption is wasted because all keys are illuminated on the operation surfaces although only a part of keys are required when the screen is scrolled, when a dial entering operation is performed, etc.

### BRIEF SUMMARY OF THE INVENTION

The object of the present invention is to provide a key backlight control method and circuit capable of illuminating only a target key in a key operation, and reducing power consumption in a key arrangement unit.

To attain the above-mentioned object, the present invention provides as the first aspect a key backlight control method for controlling a plurality of light-emitting elements which are provided on the backs of or near the respective push keys arranged on a key arrangement unit and used as the backlight of the keys. In the plurality of light-emitting elements, the light-emitting elements only corresponding to the keys required or requested by a processing mode operated based on an entering operation of the plurality of keys are turned on.

According to this method, when a processing mode (or operation mode) is performed based on the entering operation of the keys, the light-emitting elements only corresponding to the keys required or requested by the processing mode are turned on. Therefore, the light-emitting element corresponding to an unused key does not emit light, thereby reducing the power consumption for the light-emitting elements and improving the operability because the keys to be operated can be quite obvious.

To attain the above-mentioned object, the present invention provides as the second aspect a key backlight control circuit includes: a key arrangement unit on which a plurality of push keys are arranged; a plurality of light-emitting elements which are provided on the backs of or near the respective keys arranged on the key arrangement unit and used as the backlight of the keys; and control means for turning on the light-emitting elements only, in the plurality of light -emitting elements, corresponding to the keys required or requested by a processing mode performed in equipment using the key arrangement unit.

With the above-mentioned configuration, the plurality of light-emitting elements illuminating the respective keys do not simultaneously be turned on, but the light-emitting elements only corresponding to the keys required or requested by the processing mode are turned on under the control of the control means. Thus, the power consumption for the light-emitting elements can be reduced, and the keys to be operated are quite obvious, thereby improving the operability. Furthermore, since the control means can cooperate with the control of the key scanning, the entire configuration can be simplified.

### BRIEF DESCRIPTION OF THE DRAWINGS

FIG. 1 is a view of a key backlight control circuit according to a first embodiment of the present invention;

FIG. 2 is a flowchart of operations of the key backlight control circuit;

FIG. 3 is a view of a key backlight control circuit according to a second embodiment of the present invention;

FIG. 4 is an oblique view of the appearance of mobile terminal equipment; and

FIG. 5 shows the configuration of the conventional key control system and key backlight control circuit in mobile terminal equipment.

### DETAILED DESCRIPTION OF THE PREFERRED EMBODIMENTS

The embodiments of the present invention are described below by referring to the attached drawings.

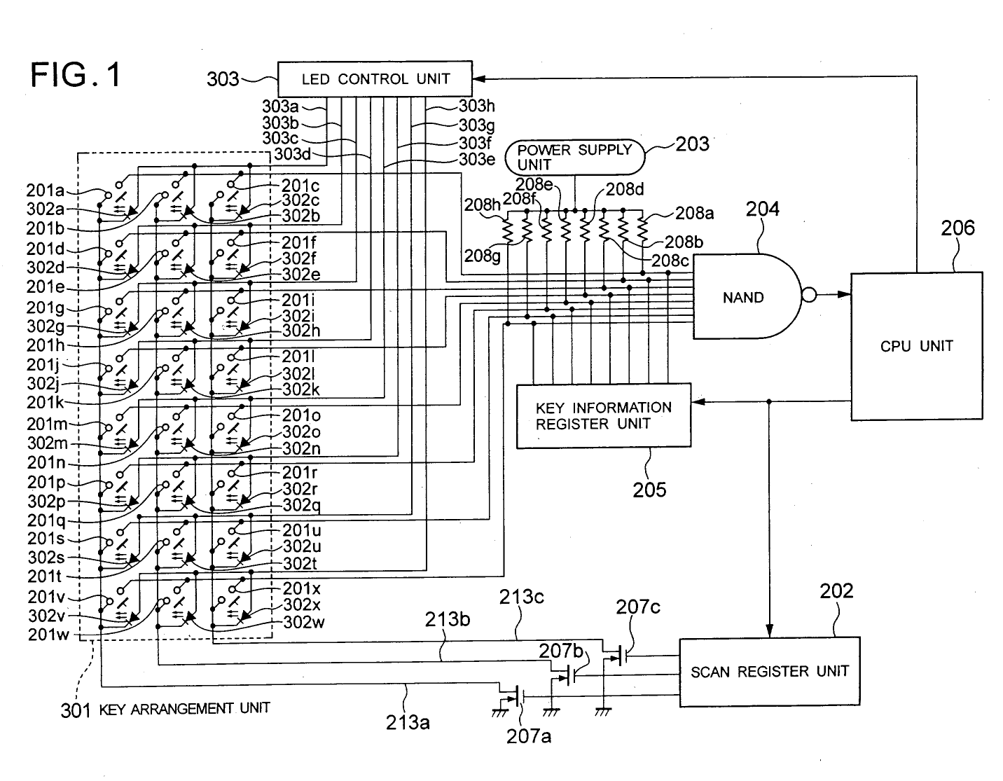

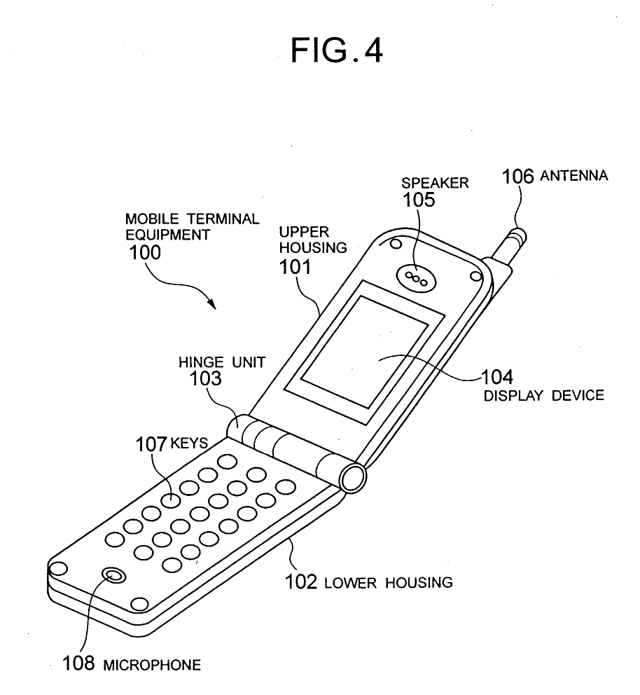

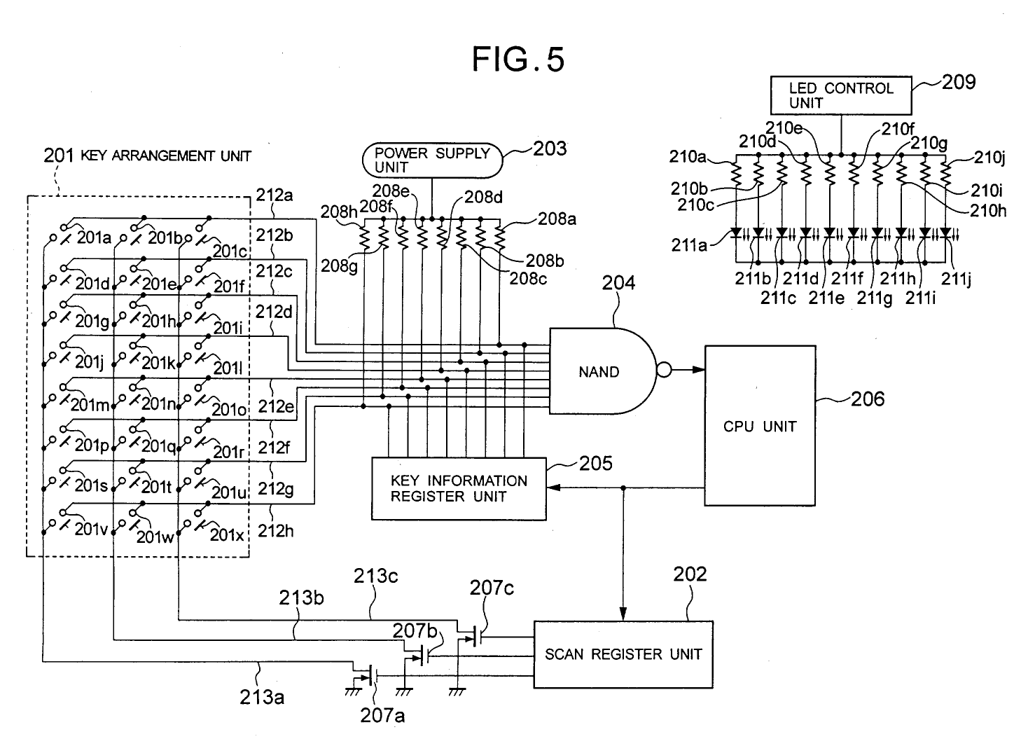

FIG. 1 shows a key backlight control circuit according to a first embodiment of the present invention. In the first embodiment of the present invention, the components also shown in FIG. 5 are assigned the same reference numerals, and the double explanation is omitted here. The equipment to which the key backlight control circuit in FIG. 1 is applied is a mobile phone unit, and the appearance is shown in FIG. 4.

In a key arrangement unit 301, LEDs 302a to 302x are respectively attached to the backs of or near keys 201a to 201x. The LEDs 302a to 302x come in luminous colors such as white, green, etc. depending on the design, etc. The LEDs 302a to 302x are divided into eight groups, and the anodes of the LEDs belonging to the respective groups are connected to output lines 303a to 303h of a LED control unit 303 respectively. The LED control unit 303 applies a voltage to an LED to be turned on in cooperation with the operation of a scan register unit 202.

That is, each anode of the LEDs 302a to 302c is connected to the output line 303a, each anode of the LEDs 302d to 302f is connected to the output line 303b, each anode of the LEDs 302g to 302i is connected to the output line 303c, each anode of the LEDs 302j to 302l is connected to the output line 303d, each anode of the LEDs 302m to 302o is connected to the output line 303e, each anode of the LEDs 302p to 302r is connected to the output line 303f, each anode of the LEDs 302s to 302u is connected to the output line 303g, and each anode of the LEDs 302v to 302x is connected to the output line 303h.

Each cathode of the LEDs 302a, 302d, 302g, 302j, 302m, 302p, 302s, and 302v is connected to a column line 213a, each cathode of the LEDs 302b, 302e, 302h, 302k, 302n, 302q, 302t, and 302w is connected to a column line 213b, and each cathode of the LEDs 302c, 302f, 302i, 302l, 302o, 302r, 302u, and 302x is connected to a column line 213c. The LEDs 302a to 302x are driven by the LED control unit 303, and the LED control unit 303 is controlled according to the output signal of a CPU unit 206.

Described below is the basic operation of the key backlight control circuit shown in FIG. 1. The scan register unit 202 sequentially one by one turns on FETs 207a to 207c according to a signal from the CPU unit 206. When any key of the key arrangement unit 301 is depressed during scanning by the scan register unit 202, the change of the output voltage of the key is detected by a NAND gate 204, and a signal is transmitted from the NAND gate 204 to the CPU unit 206. When the signal is generated in the NAND gate 204, the CPU unit 206 obtains the information about which in the FETs 207a to 207c is turned on and the information stored in a key information register unit 205 (which bit is set in the low state), and recognizes which key is depressed. Then, the CPU unit 206 controls the LED control unit 303 to turn on the LED corresponding to the depressed key. To turn on the LED connected to the line of the FET 207b or 207c, it is necessary to switch the ON state from the FET 207a to the FET 207b or 207c (turn on the FET 207b or 207c). When the FETs are switched, an arbitrary LED can be turned on by switching the voltage applied by the LED control unit 303 to the LED.

For example, if the key 201a is depressed, then the CPU unit 206 detects it and controls the LED control unit 303 to turn on the LED 302a. The LED control unit 303 sets the output line 303a in the high state. At this time, since the FET 207a is turned on by the scan register unit 202 for scanning, the current flows through the LED 302a via the path of the LED control unit 303→output line 303a→LED 302a→FET 207a, and the LED 302a is turned on. In addition to the operated key (depressed key), it is possible to turn on the LEDs corresponding to a plurality of surrounding keys.

Described above is an example of illuminating a key by turning on the LED corresponding to the key depending on the operation of the key regardless of the display contents of the LCD 104 shown in FIG. 4. It is also possible to illuminate a key which can be operated (depressed) depending on the display contents of the screen. For example, when the screen of the LCD 104 is the selection screen for selection of “Yes”/“No”, only the direction key (or a cross key) or the determination key is illuminated. Furthermore, when mail or Internet is viewed, the up-down key for scroll, the next page key, the return key, etc. are illuminated. During dialing or entering characters, the ten-keys (number keys) are illuminated. Thus, by turning off the light of the invalid keys to be depressed, the power consumption can be reduced and the operability can be improved.

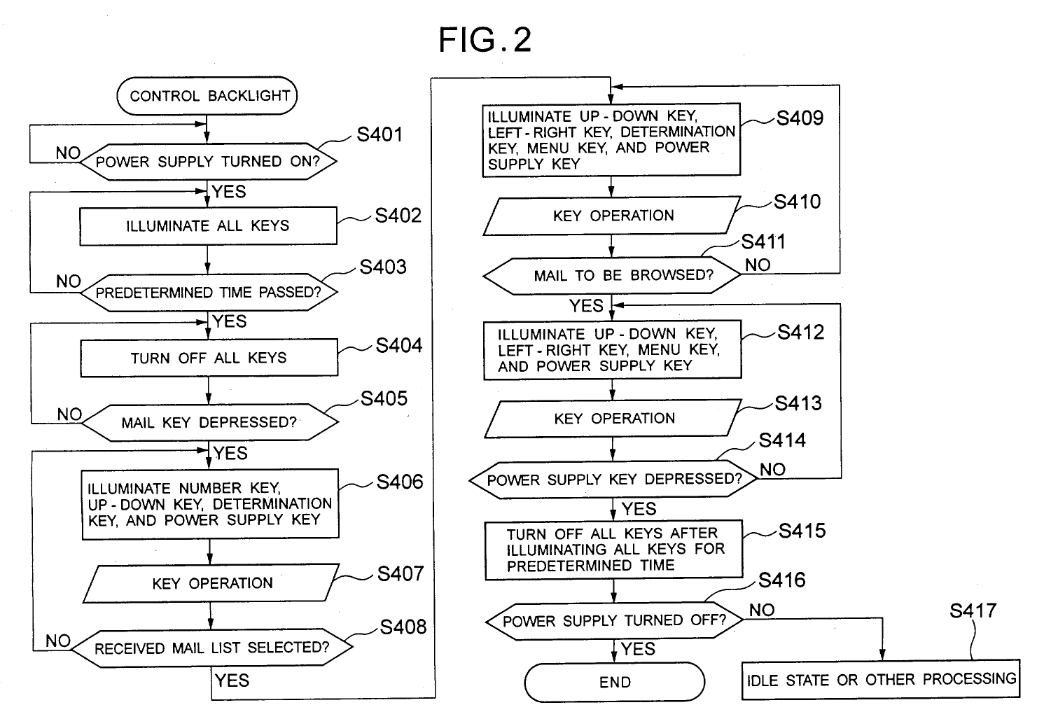

FIG. 2 shows the operation of the key backlight control circuit shown in FIG. 1 performed when received mail is browsed by the mobile terminal equipment having the key backlight control circuit. In this example, the mobile terminal equipment is assumed to be the mobile phone unit shown in FIG. 4, and a turned-on state of the LED is described as the key being lit up. If the power supply key is depressed (S401), the CPU unit 206 controls the scan register unit 202 and the LED control unit 303 to turn on all the LEDs 302a to 302x on the key arrangement unit 301, and illuminates the keys 201a to 201x (S402). If any key is depressed in this state, then the NAND gate 204 detects it, the CPU unit 206 determines which key has been depressed from the operation state of the NAND gate 204 and the scan register unit 202, and performs a predetermined operation such as a display processing. When a predetermined time passes after the last key operation is performed (S403), all the LEDs 302a to 302x are turned off (S404).

In this state, if the “mail key” is depressed to browse a received mail (S405), then the CPU unit 206 displays the menu relating to an E-mail on the LCD 104. Furthermore, the CPU unit 206 controls the scan register unit 202 and the LED control unit 303 to illuminate the “number key” for selection of a menu, the “up-down key” for switch of a selection position, the “determination key”, and the “power supply key” for termination of menu display and return to a normal state (S406) without illuminating the other keys. Since the user can recognize that only the illuminated keys are to be operated, the user performs an entering operation by operating the illuminated keys only (S407).

When the user selects the “received mail list” by referring to the menu (not shown in the attached drawings) being displayed on the LCD 104 (S408), a list of received mails is displayed on the LCD 104. Simultaneously, the CPU unit 206 controls the scan register unit 202 and the LED control unit 303 to illuminate the “up-down key, left-right key, and determination key” for selection of the mail to be browsed, the “menu key” for performance of a special operation, the “power supply key” for return to a normal state by terminating the menu display (S409). In this state, the user can recognize that only the illuminated keys are to be operated, and necessary keys are operated to perform an entering operation (S410).

When the user selects the mail to be browsed from the list of the received mails displayed on the LCD 104 by operating the keys (S411), the CPU unit 206 displays the contents of the selected mail on the LCD 104. Simultaneously, the CPU unit 206 controls the scan register unit 202 and the LED control unit 303 to illuminate the “up-down key” for scroll of the displayed contents, the “left-right key” for browse of the previous or subsequent mail, the “menu key” for performance of a special operation, and the “power supply key” for return to a normal state by terminating the menu (S412). The user operates the “up-down key” and the “left-right key” (S413) to browse the mail. When the user finishes browsing the mail, and depresses the power supply key (S414), the CPU unit 206 illuminates all keys, and allows the user to recognize that all keys can be operated. After a predetermined period passes with no keys depressed while all keys are being illuminated, all keys (all LEDs) are turned off (S415). Then, the power supply key is depressed, it is determined whether or not the power is turned off (S416), and the mobile phone unit enters an idle state if the power is not turned off (S417). If it is determined that the power is turned off after the power supply key is depressed for several seconds, all operations terminate on the mobile phone unit.

As described above, when the mobile phone unit enters a processing mode (operation mode), only the keys to be operated in the processing mode are illuminated. Therefore, the user can immediately operate the necessary keys without consideration of other keys. Additionally, since only the LEDs corresponding to the keys to be operated are turned on, the required power consumption can be minimized, and the power consumption for the mobile terminal equipment such as a mobile phone unit can be reduced.

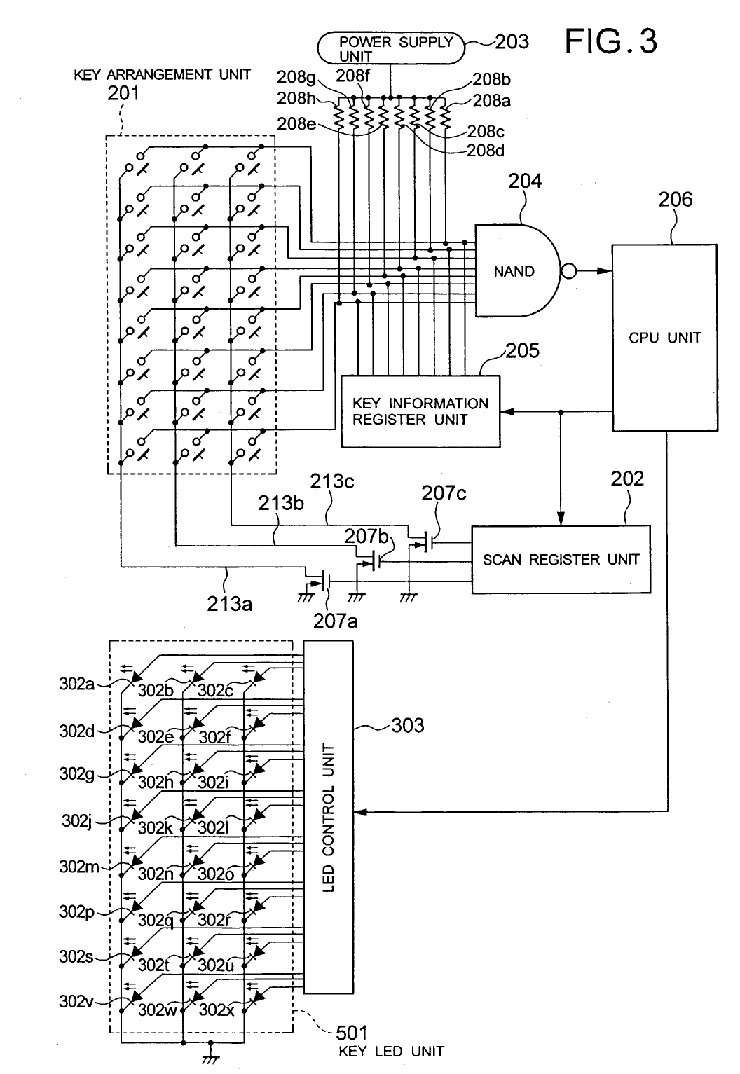

FIG. 3 shows a key backlight control circuit according to a second embodiment of the present invention. In FIG. 3, the components also shown in FIG. 1 are assigned the same reference numerals, and the double explanation is omitted here.

The first embodiment is configured by the key arrangement unit 301 in which the key arrangement unit 201 and the LEDs 211a to 211j shown in FIG. 5 are incorporated into one structure, but the second embodiment is, as shown in FIG. 5, configured by the key arrangement unit 201 separated from a key LED unit 501, and the key LED unit 501 is arranged on the back of the key arrangement unit 201. With the configuration, the key arrangement unit 201 and the key LED unit 501 can be individually procured. Furthermore, the mobile terminal equipment not provided with the key LED unit 501 can be easily prepared independent of the mobile terminal equipment having the key LED unit 501.

In the first and second embodiments, LEDs are used for light-emitting elements as the light source of the backlight, but the present invention is not limited to the LEDs. For example, organic EL elements can be used.

As described above, according to the key backlight control method of the present invention, when a processing mode (or operation mode) is performed based on the entering operation of a plurality of keys, light-emitting elements only, in a plurality of light-emitting elements for respectively illuminating the plurality of keys, corresponding to the keys required or requested by the processing mode are turned on. Therefore, the light-emitting elements corresponding to unused keys are not turned on, thereby reducing the power consumption for the light-emitting elements, allowing the user to immediately find the keys to be operated, and improving the operability.

Additionally, according to the key backlight control circuit of the present invention, a plurality of light-emitting elements are provided on the back of or near the respective keys on a key arrangement unit, and control means turns on only the light-emitting elements corresponding to the keys required by the operating mode of the mobile terminal equipment. Therefore, all light-emitting elements are not simultaneously turned on, but only the light-emitting elements corresponding to the keys required or requested by the processing mode are turned on under the control of the control means. Therefore, the power consumption for the light-emitting elements can be reduced. Furthermore, since the turned-on state of the light-emitting elements immediately indicates the keys to be operated, thereby improving the operability. Additionally, since the control mean scan cooperate with the control of the key scanning operation, the-entire configuration can be simplified.

What is claimed is:

1. A key backlight control method for controlling a plurality of light-emitting elements which are provided on backs of or near respective of a plurality of push keys arranged on a key arrangement unit and used as the backlight of said plurality of keys, wherein
of said plurality of light-emitting elements, the light-emitting elements only corresponding to the keys required or requested by a processing mode operated based on an entering operation of said plurality of keys are turned on.

2. A key backlight control circuit, comprising:
a key arrangement unit on which a plurality of push keys are arranged;
a plurality of light-emitting elements which are provided on backs of or near respective of said plurality of keys and used as the backlight of said plurality of keys; and
control means for turning on the light-emitting elements only, in said plurality of light-emitting elements, corresponding to the keys required or requested by a processing mode performed in equipment using said key arrangement unit.

3. The key backlight control circuit according to claim 2, wherein
when any of said plurality of keys is operated, said control means performs the processing mode according to the operation and turns on the light-emitting elements corresponding to the keys required or requested by the processing mode.

4. The key backlight control circuit according to claim 2, wherein
said plurality of light-emitting elements are incorporated into said key arrangement unit as respectively corresponding to said plurality of keys.

5. The key backlight control circuit according to claim 2, wherein,
said plurality of light-emitting elements are designed as an assembly unit to be attached to said key arrangement unit.

6. The key backlight control circuit according to claim 2, wherein
said light-emitting elements are light-emitting diodes.

7. The key backlight control circuit according to claim 2, wherein
said equipment is a mobile phone.
